(19) United States
(12) Patent Application Publication
(10) Pub. No.: US 2005/0168967 A1
(43) Pub. Date: Aug. 4, 2005

(54) Backlight module

(76) Inventors: Ko-Chia Kao, Jiouru Township (TW); Shen-Hong Chou, Kaohsiung City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/768,847

(22) Filed: Jan. 30, 2004

(51) Int. Cl. G01D 11/28

(52) U.S. Cl. 362/27

(57) ABSTRACT

A backlight module. The backlight module includes a diffuser plate, a first light guide plate, a second light guide plate, a plurality of first light sources, and a plurality of second light sources. The first light sources are disposed adjacent to the first light guide plate and emit light through the first guide plate to the diffuser plate. The second light sources are disposed adjacent to the second light guide plate and emit light through the second light guide plate to the diffuser.

### BACKGROUND OF THE INVENTION

1. Field of the Invention

The present invention relates to a backlight module, and in particular to a backlight module for a liquid crystal display merging light emitted from light sources of different colors.

2. Description of the Related Art

FIG. 1 is a vertical schematic diagram of a conventional direct backlight module in a liquid crystal display. Backlight sources of the conventional direct backlight module are red, green, and blue light emitting diodes. Red, green, and blue light respectively emitted from the red, green, and blue light emitting diodes is merged to generate white light. As shown in FIG. 1, a plurality of light emitting diodes are located between a housing 11 and a diffuser plate 10. The light emitting diodes L₁₁, L₁₂ to L₁ₘ are disposed in the first column, light emitting diodes L₁₁, L₂₂ to L₂ₘ in the second column, and light emitting diodes Lₙ₁, Lₙ₂ to Lₙₘ in the third column.

FIG. 2 is a schematic cross-section along the line 2-2 in FIG. 1. A space 3 is formed between the housing 11 and the diffuser plate 10. An inner surface of the housing 11 has a reflective layer 12. The light emitting diodes L₁₁, L₂₁ and L₁ₘ are disposed at the bottom of the housing 11 in the space 13. In this direct backlight module, the distance over which the light, emitted from the red, green, and blue light emitting diodes merges to produce the white light, is longer. Generally, this distance is twice as long as that between two light emitting diodes. For example, in FIG. 1, p represents the distance between the light emitting diodes, such as L₁₁ and L₂₁. In order to achieve more uniform light merging, a distance d (the distance of light merging) between the light emitting diode L₁₁ and the diffuser plate 10 is twice as long as the distance p. Thus, arrangement of the light emitting diodes limits the distance for light merging, and longer merging distance increases size and volume of the backlight module. In addition, because of the arrangement of the light emitting diodes, dark areas occur in the corners of a panel of the liquid crystal display.

### SUMMARY OF THE INVENTION

Accordingly, an object of the present invention is to provide a backlight module for a liquid crystal display of direct light type to uniformly merge different color light while decreasing the merging distance, reducing size of the backlight module.

To achieve this object, the present invention provides a backlight module. The backlight module comprises a diffuser plate, a first light guide plate, a second light guide plate, a plurality of first light sources, and a plurality of second light sources. The first light sources are disposed adjacent to the first light guide plate and emit light through the first guide plate to the diffuser plate. The second light guide plate is disposed between the first light sources and the diffuser plate. The second light sources are disposed adjacent to the second light guide plate and emit light through the second light guide plate to the diffuser.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a vertical schematic diagram of a conventional direct backlight module in a liquid crystal display.

FIG. 2 is a schematic cross-section along the line 2-2 in FIG. 1.

FIG. 3 is a vertical schematic diagram of a direct backlight module in a liquid crystal display according to the present invention.

FIG. 4 is a schematic cross-section along the line 4-4 in FIG. 3.

FIG. 5 is a vertical schematic diagram of arrangement of the light guide plates and the light emitting diodes according to the present invention.

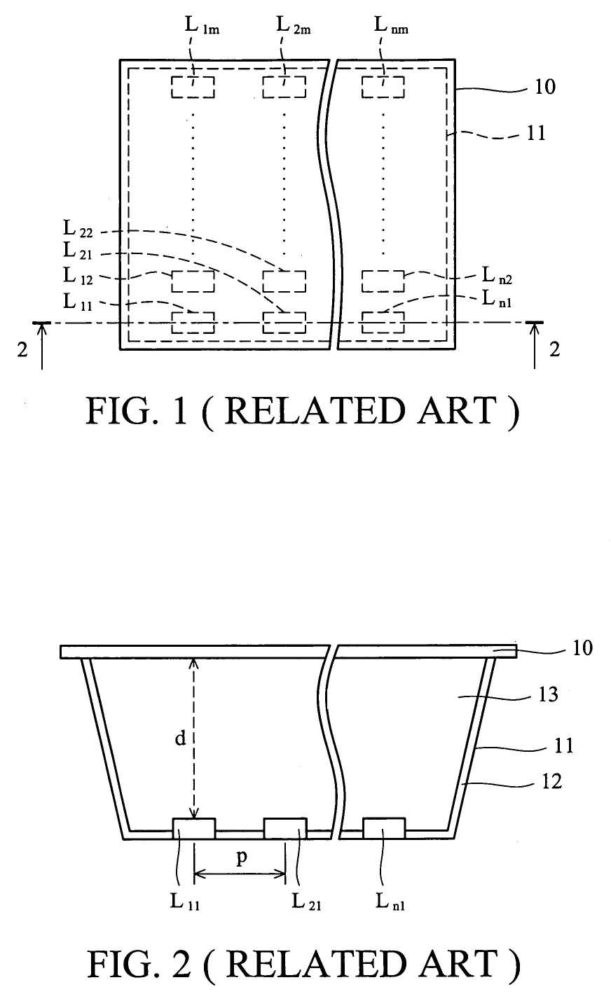

### DETAILED DESCRIPTION OF THE INVENTION

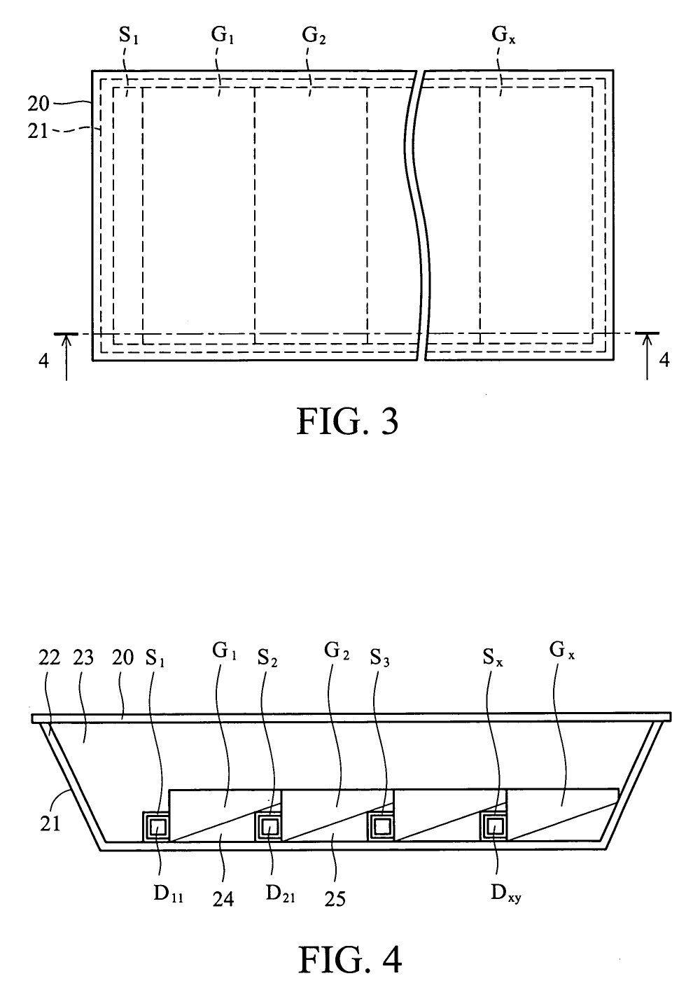

FIG. 3 is a vertical schematic diagram of a direct backlight module in a liquid crystal display according to the present invention. FIG. 4 is a schematic cross-section along the line 4-4 in FIG. 3. The backlight of the present invention produces white light by merging red, green, and blue light respectively emitted from the red, green, and blue light emitting diodes. Referring to FIGS. 3 and 4, the direct backlight module of the present invention comprises a diffuser plate 20, a housing 21, light guide plates G₁ to Gₓ, elongated shades S₁ to Sₓ, and a plurality of light emitting diodes. The space in which the light guide plates G₁ to Gₓ, the elongated shades S₁ to Sₓ, and the light emitting diodes are disposed is formed between the housing 21 and the diffuser plate 20.

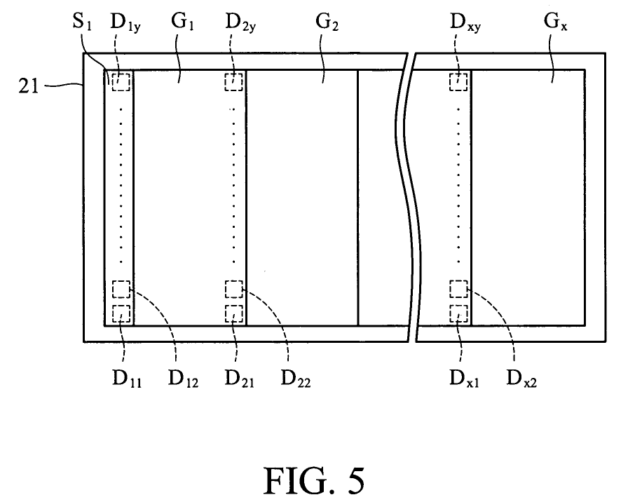

FIG. 5 is a vertical schematic diagram of arrangement of the light guide plates and the light emitting diodes according to the present invention. The light guide plates G₁ to Gₓ are adjacent to each other. The light emitting diodes D₁₁, D₁₂ to D_{1y} are disposed in a first column and on a side of the light guide plates G₁, opposite to the light guide plates G₂. The light emitting diodes D₂₁, D₂₂ to D_{2y} are disposed in a second column and under the light guide plates G₂. The light emitting diodes Dₓ₁, Dₓ₂ to D_{xy} are disposed in a x-th column and under the light guide plates Gₓ. The first, second and x-th columns are parallel. In the present invention, the light emitting diodes D₁₁, D₁₂ to D_{1y} disposed in the first column can comprise red, green, and blue light emitting diodes, as can those in the second and x-th column. Moreover, the light emitting diodes D₁₁, D₁₂ to D_{1y} are covered by the elongated shades S₁, the light emitting diodes D₂₁, D₂₂ to D_{2y} are covered by the elongated shades S₂ (not shown in FIG. 5), and the light emitting diodes Dₓ₁, Dₓ₂ to D_{xy} are covered by the elongated shades Sₓ (not shown in FIG. 5).

A more detailed description is given with reference to FIG. 4. As shown in FIG. 4, the light guide plates G₁ and G₂ are wedge-shaped and front surfaces of the light guide plates G₁ and G₂ are both disposed on a virtual plate. The light guide plate G₁ and G₂ respectively have back surfaces facing a inner surface of the housing 20, and the back surfaces of the light guide plate G₁ and G₂ are inclined with respect to the inner surface of the housing 21 to respectively define the spaces 24 and 25 therebetween. The light emitting diode D₁₁ is disposed on the thick side of the light guide plate G₁ and covered by the elongated shades S₁. Light from the light emitting diode D₁₁ is emitted through the guide plate G₁ to the diffuser plate 20. The light emitting diode D₂₁ is disposed on the thick side of the light guide plate G₂ and covered by the elongated shades S₂. Similarly, light from the light emitting diode D₂₁ is emitted through the guide plate G₂ to the diffuser plate 20.

In the present invention, in order to completely utilize the light from the light emitting diodes, inner surfaces of the elongated shades S₁ to Sₓ have reflective surfaces (not shown), and the inner surface of the housing 21 also has a reflective layer 22.

When the light emitting diode D₁₁ emits light, the light is reflected by the reflective surface of the elongated shade S₁ to the light guide plate G₁. The light guide plate G₁ merges the light from the light emitting diode D₁₁ and converts the merged light to planar light. The planar light from the light guide plate G₁ is then emitted to the diffuser plate 20. Planar light from the light guide plate G₁ reaching the housing 21 is reflected to the diffuser plate 20 by the reflective layer 22 of the housing 21. Similarly, when the light emitting diode D₂₁ emits light, the light is reflected by the reflective surface of the elongated shade S₂ to the light guide plate G₂. The light guide plate G₂ merges the light from the light emitting diode D₂₁ and converts the merged light to planar light. The planar light from the light guide plate G₂ is then emitted to the diffuser plate 20. Planar light from the light guide plate G₂ reaching the housing 21 is reflected to the diffuser plate 20 by the reflective layer 22 of the housing 21. Finally, the diffuser plate 20 merges the planar light from the light guide plate G₁ and the planar light from the light guide plate G₂, eliminating direction of light.

The present invention provides merging of light emitted from the red, green, and blue light emitting diodes by, first, light guide plate and then a diffuser plate, whereby merging distance is minimized. Such that size and volume of the backlight module are decreased while still enabling uniformly merged light.

In the present invention, the number of light emitting diodes in a column can be determined according to system wants requirements, without limitation.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A backlight module comprising:
a diffuser plate;
a first light guide plate;
a plurality of first light sources, disposed adjacent to the first light guide plate, emitting light through the first guide plate to the diffuser plate;
a second light guide plate disposed between the plurality of first light sources and the diffuser plate; and
a plurality of second light sources, disposed adjacent to the second light guide plate, emitting light through the second light guide plate to the diffuser.

2. The backlight module as claimed in claim 1, wherein the plurality of first light sources are arranged in a first line.

3. The backlight module as claimed in claim 2, further comprising a first elongated shade partly covering the plurality of first light sources.

4. The backlight module as claimed in claim 3, wherein the first elongated shade has reflective inner surfaces.

5. The backlight module as claimed in claim 2, wherein the plurality of second light sources are arranged in a second line.

6. The backlight module as claimed in claim 5, further comprising a second elongated shade partly covering the plurality of second light sources.

7. The backlight module as claimed in claim 6, wherein the second elongated shade has reflective inner surfaces.

8. The backlight module as claimed in claim 5, wherein the first line and the second line are parallel.

9. The backlight module as claimed in claim 1, further comprising a housing to house the first light guide plate, the plurality of first light sources, the second light guide plate, and the plurality of second light sources.

10. The backlight module as claimed in claim 9, wherein the second guide plate is wedge-shaped, and the housing and the second light guide plate define a space therebetween to receive the plurality of first light sources.

11. The backlight module as claimed in claim 10, wherein the housing has an inner surface, the second light guide plate has a back surface facing the inner surface of the housing, and the back surface of the second light guide plate is inclined with respect to the inner surface of the housing to define the space therebetween.

12. The backlight module as claimed in claim 11, wherein the inner surface of the housing has a reflective layer.

13. The backlight module as claimed in claim 1, wherein the first light guide and the second light guide are both on a virtual plate.

14. The backlight module as claimed in claim 1, wherein the plurality of first light sources and the plurality of second light sources are light emitting diodes.
